(19) United States
(12) Patent Application Publication
(10) Pub. No.: US 2013/0334104 A1
(43) Pub. Date: Dec. 19, 2013

(54) DISTILLING A CHEMICAL MIXTURE USING AN ELECTROMAGNETIC RADIATION-ABSORBING COMPLEX FOR HEATING

(71) Applicants: Nancy J. Halas, Houston, TX (US); Peter Nordlander, Houston, TX (US); Oara Neumann, Houston, TX (US)

(72) Inventors: Nancy J. Halas, Houston, TX (US); Peter Nordlander, Houston, TX (US); Oara Neumann, Houston, TX (US)

(73) Assignee: WILLIAM MARSH RICE UNIVERSITY, Houston, TX (US)

(21) Appl. No.: 13/992,863

(22) PCT Filed: Nov. 30, 2011
(86) PCT No.: PCT/US11/62497

§ 371 Date: Aug. 12, 2013

Related U.S. Application Data
(60) Provisional application No. 61/423,250, filed on Dec. 15, 2010.

(51) Int. Cl. B01D 3/34

(52) U.S. Cl. CPC B01D 3/34
USPC 208/348; 203/86; 203/99; 203/71; 203/22; 202/163; 202/185.1; 202/175; 203/50

(57) ABSTRACT

A method of distilling a chemical mixture, the method including receiving, in a vessel comprising a complex, the chemical mixture comprising a plurality of fluid elements, applying electromagnetic (EM) radiation to the complex, wherein the complex absorbs the EM radiation to generate heat at a first temperature, transforming, using the heat generated by the complex, a first fluid element of the plurality of fluid elements of the chemical mixture to a first vapor element, and extracting the first vapor element from the vessel, where the complex is at least one selected from a group consisting of copper nanoparticles, copper oxide nanoparticles, nanoshells, nanorods, carbon moieties, encapsulated nanoshells, encapsulated nanoparticles, and branched nanostructures.

### CROSS REFERENCE TO RELATED APPLICATIONS

This application claims priority under 35 U.S.C. §119(e) to U.S. Provisional Patent Application Ser. No. 61/423,250, which is incorporated by reference in its entirety.

### STATEMENT REGARDING FEDERALLY SPONSORED RESEARCH OR DEVELOPMENT

The present invention was made with government support under Award Number DE-AC52-06NA25396 awarded by the Department of Energy. The government has certain rights in the invention.

### BACKGROUND

The process of distilling a chemical mixture involves applying a controlled amount of energy (e.g., heat) to a chemical mixture. The chemical mixture includes a number of elements that each has different characteristics, such as a boiling point. By applying controlled energy to the chemical mixture in fluid form, one of the elements with the lowest boiling point may evaporate while the remaining elements in the chemical mixture may remain in fluid form. As a result, the element that evaporated may be captured as a vapor, extracted from the remainder of the chemical mixture. The captured element may then be condensed back into fluid form, isolated from the remainder of the chemical mixture. This process may be repeated using increased amounts of energy to isolate and extract other elements from the remainder of the chemical mixture.

### SUMMARY

In general, in one aspect, the invention relates to a method of distilling a chemical mixture, the method comprising receiving, in a vessel comprising a complex, the chemical mixture comprising a plurality of fluid elements, applying electromagnetic (EM) radiation to the complex, wherein the complex absorbs the EM radiation to generate heat at a first temperature, transforming, using the heat generated by the complex, a first fluid element of the plurality of fluid elements of the chemical mixture to a first vapor element, and extracting the first vapor element from the vessel, where the complex is at least one selected from a group consisting of copper nanoparticles, copper oxide nanoparticles, nanoshells, nanorods, carbon moieties, encapsulated nanoshells, encapsulated nanoparticles, and branched nanostructures.

In general, in one aspect, the invention relates to a system for distilling a chemical mixture, the system comprising a vessel comprising a complex and configured to receive the chemical mixture comprising a plurality of elements, apply electromagnetic (EM) radiation to the complex, wherein the complex absorbs the EM radiation to generate heat, transform, using the heat generated by the complex, a first fluid element of the plurality of fluid elements in the first vessel to a first vapor element, where the remainder of the plurality of fluid elements forms a modified chemical mixture in the vessel, where the complex is at least one selected from a group consisting of copper nanoparticles, copper oxide nanoparticles, nanoshells, nanorods, carbon moieties, encapsulated nanoshells, encapsulated nanoparticles, and branched nanostructures.

### BRIEF DESCRIPTION OF DRAWINGS

FIG. 1 shows a schematic of a complex in accordance with one or more embodiments of the invention.

FIG. 2 shows a flow chart in accordance with one or more embodiments of the invention.

FIG. 3 shows a chart of the absorbance in accordance with one or more embodiments of the invention.

FIGS. 4A-4B show charts of an energy dispersive x-ray spectroscopy (EDS) measurement in accordance with one or more embodiments of the invention.

FIG. 5 shows a chart of the absorbance in accordance with one or more embodiments of the invention.

FIG. 6 shows a chart of an EDS measurement in accordance with one or more embodiments of the invention.

FIG. 7 shows a chart of the absorbance in accordance with one or more embodiments of the invention.

FIG. 8 shows a flow chart in accordance with one or more embodiments of the invention.

FIG. 9 shows a chart of the absorbance in accordance with one or more embodiments of the invention.

FIG. 10 shows a chart of an EDS measurement in accordance with one or more embodiments of the invention.

FIGS. 11A-11C show charts of the porosity of gold corral structures in accordance with one or more embodiments of the invention.

FIGS. 12A-12C show charts of the mass loss of water into steam in accordance with one or more embodiments of the invention.

FIGS. 13A-13B show charts of the energy capture efficiency in accordance with one or more embodiments of the invention.

FIG. 14 shows a system in accordance with one or more embodiments of the invention.

FIG. 15 shows a flowchart for a method of distilling a chemical mixture in accordance with one or more embodiments of the invention.

FIGS. 16 through 17 each show a single line diagram of an example system for distilling a chemical mixture in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide for distilling a chemical mixture using an electromagnetic (EM) radiation-absorbing complex. More specifically, one or more embodiments of the invention provide for adding energy (e.g., heat) to a chemical mixture (i.e., a fluid that includes a number of elements, where each element has a unique boiling point relative to the other elements in the chemical mixture) in order to separate and extract one of the elements from the chemical mixture. Each element separated and extracted from the chemical mixture may be substantially pure. For example, argon extracted from air using distillation may be more than 95%, but less than 100%, pure.

Embodiments of the invention use complexes (e.g., nanoshells) that have absorbed EM radiation to produce the energy used to generate the heated fluid. The invention may provide for a complex mixed in a liquid solution, used to coat a wall of a vessel, integrated with a material of which a vessel is made, and/or otherwise suitably integrated with a vessel used to apply EM radiation to the complex. All the piping and associated fittings, pumps, valves, gauges, and other equipment described, used, or contemplated herein, either actually or as one of ordinary skill in the art would conceive, are made of materials resistant to the heat and/or fluid and/or vapor transported, transformed, pressurized, created, or otherwise handled within those materials.

A source of EM radiation may be any source capable of emitting energy at one or more wavelengths. For example, EM radiation may be any source that emits radiation in the ultraviolet, visible, and infrared regions of the electromagnetic spectrum. A source of EM radiation may be manmade or occur naturally. Examples of a source of EM radiation may include, but are not limited to, the sun, waste heat from an industrial process, and a light bulb. One or more concentrators may be used to intensify and/or concentrate the energy emitted by a source of EM radiation. Examples of a concentrator include, but are not limited to, lens(es), a parabolic trough(s), mirror(s), black paint, or any combination thereof.

Embodiments of this invention may be used in any residential, commercial, and/or industrial application where heating of a fluid may be needed. Examples of such applications include, but are not limited to, alcohol production (e.g., ethanol, methanol) as for a biofuels plant, chemical treatment, chemicals and allied products, (e.g., rubber, plastics, textile production), laboratories, perfumeries, air products (e.g., argon, hydrogen, oxygen), drug manufacturing, and alcoholic beverages.

In one or more embodiments, the complex may include one or more nanoparticle structures including, but not limited to, nanoshells, coated nanoshells, metal colloids, nanorods, branched or coral structures, and/or carbon moieties. In one or more embodiments, the complex may include a mixture of nanoparticle structures to absorb EM radiation. Specifically, the complex may be designed to maximize the absorption of the electromagnetic radiation emitted from the sun. Further, each complex may absorb EM radiation over a specific range of wavelengths.

In one or more embodiments, the complex may include metal nanoshells. A nanoshell is a substantially spherical dielectric core surrounded by a thin metallic shell. The plasmon resonance of a nanoshell may be determined by the size of the core relative to the thickness of the metallic shell. Nanoshells may be fabricated according to U.S. Pat. No. 6,685,986, hereby incorporated by reference in its entirety. The relative size of the dielectric core and metallic shell, as well as the optical properties of the core, shell, and medium, determines the plasmon resonance of a nanoshell. Accordingly, the overall size of the nanoshell is dependent on the absorption wavelength desired. Metal nanoshells may be designed to absorb or scatter light throughout the visible and infrared regions of the electromagnetic spectrum. For example, a plasmon resonance in the near infrared region of the spectrum (700 nm-900 nm) may have a substantially spherical silica core having a diameter between 90 nm-175 nm and a gold metallic layer between 4 nm-35 nm.

A complex may also include other core-shell structures, for example, a metallic core with one or more dielectric and/or metallic layers using the same or different metals. For example, a complex may include a gold or silver nanoparticle, spherical or rod-like, coated with a dielectric layer and further coated with another gold or silver layer. A complex may also include other core-shell structures, for example hollow metallic shell nanoparticles and/or multi-layer shells.

In one or more embodiments, a complex may include a nanoshell encapsulated with a dielectric or rare earth element oxide. For example, gold nanoshells may be coated with an additional shell layer made from silica, titanium or europium oxide.

In one embodiment of the invention, the complexes may be aggregated or otherwise combined to create aggregates. In such cases, the resulting aggregates may include complexes of the same type or complexes of different types.

In one embodiment of the invention, complexes of different types may be combined as aggregates, in solution, or embedded on substrate. By combining various types of complexes, a broad range of the EM spectrum may be absorbed.

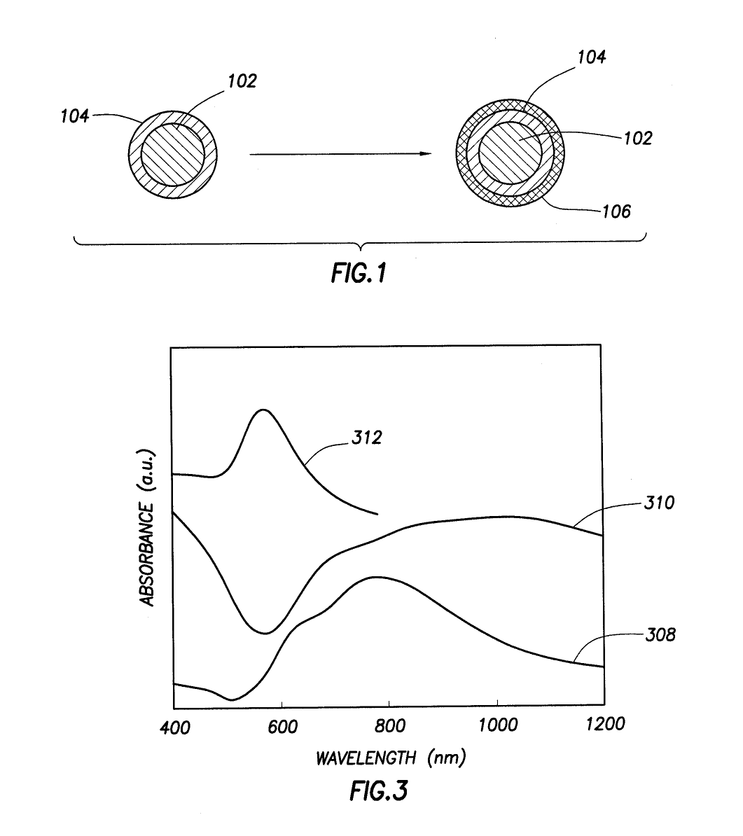

FIG. 1 is a schematic of a nanoshell coated with an additional rare earth element oxide in accordance with one or more embodiments of the invention. Typically, a gold nanoshell has a silica core 102 surrounded by a thin gold layer 104. As stated previously, the size of the gold layer is relative to the size of the core and determines the plasmon resonance of the particle. According to one or more embodiments of the invention, a nanoshell may then be coated with a dielectric or rare earth layer 106. The additional layer 106 may serve to preserve the resultant plasmon resonance and protect the particle from any temperature effects, for example, melting of the gold layer 104.

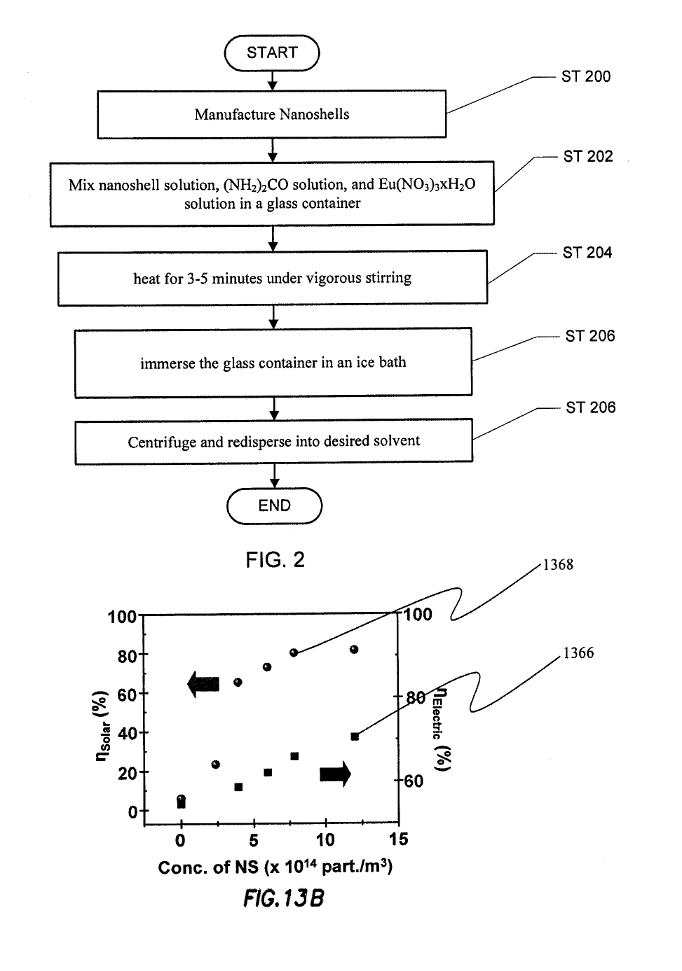

FIG. 2 is a flow chart of a method of manufacturing the coated nanoshells in accordance with one or more embodiments of the invention. In ST 200, nanoshells are manufactured according to known techniques. In the example of europium oxide, in ST 202, 20 mL of a nanoshell solution may be mixed with 10 mL of 2.5 M (NH₂)₂CO and 20 mL of 0.1 M of Eu(NO₃)₃xH₂O solutions in a glass container. In ST 204, the mixture may be heated to boiling for 3-5 minutes under vigorous stirring. The time the mixture is heated may determine the thickness of the additional layer, and may also determine the number of nanoparticle aggregates in solution. The formation of nanostructure aggregates is known to create additional plasmon resonances at wavelengths higher than the individual nanostructure that may contribute to the energy absorbed by the nanostructure for heat generation. In ST 206, the reaction may then be stopped by immersing the glass container in an ice bath. In ST 208, the solution may then be cleaned by centrifugation, and then redispersed into the desired solvent. The additional layer may contribute to the solubility of the nanoparticles in different solvents. Solvents that may be used in one or more embodiments of the invention include, but are not limited to, water, ammonia, ethylene glycol, and glycerin.

In addition to europium, other examples of element oxides that may be used in the above recipe include, but are not limited to, erbium, samarium, praseodymium, and dysprosium. The additional layer is not limited to rare earth oxides. Any coating of the particle that may result in a higher melting point, better solubility in a particular solvent, better deposition onto a particular substrate, and/or control over the number of aggregates or plasmon resonance of the particle may be used. Examples of the other coatings that may be used, but are not limited to silica, titanium dioxide, polymer-based coatings, additional layers formed by metals or metal alloys, and/or combinations of materials.

FIG. 3 is an absorbance spectrum of three nanoparticle structures that may be included in a complex in accordance with one or more embodiments disclosed herein. In FIG. 3, a gold nanoshell spectrum 308 may be engineered by selecting the core and shell dimensions to obtain a plasmon resonance peak at ˜800 nm. FIG. 3 also includes a Eu₂O₃-encapsulated gold nanoshell spectrum 310, where the Eu₂O₃-encapsulated gold nanoshell is manufactured using the same nanoshells from the nanoshell spectrum 308. As may be seen in FIG. 3, there may be some particle aggregation in the addition of the europium oxide layer. However, the degree of particle aggregation may be controlled by varying the reaction time described above. FIG. 3 also includes a ˜100 nm diameter spherical gold colloid spectrum 312 that may be used to absorb electromagnetic radiation in a different region of the electromagnetic spectrum. In the specific examples of FIG. 3, the Eu₂O₃-encapsulated gold nanoshells may be mixed with the gold colloids to construct a complex that absorbs any EM radiation from 500 nm to greater than 1200 nm. The concentrations of the different nanoparticle structures may be manipulated to achieve the desired absorption of the complex.

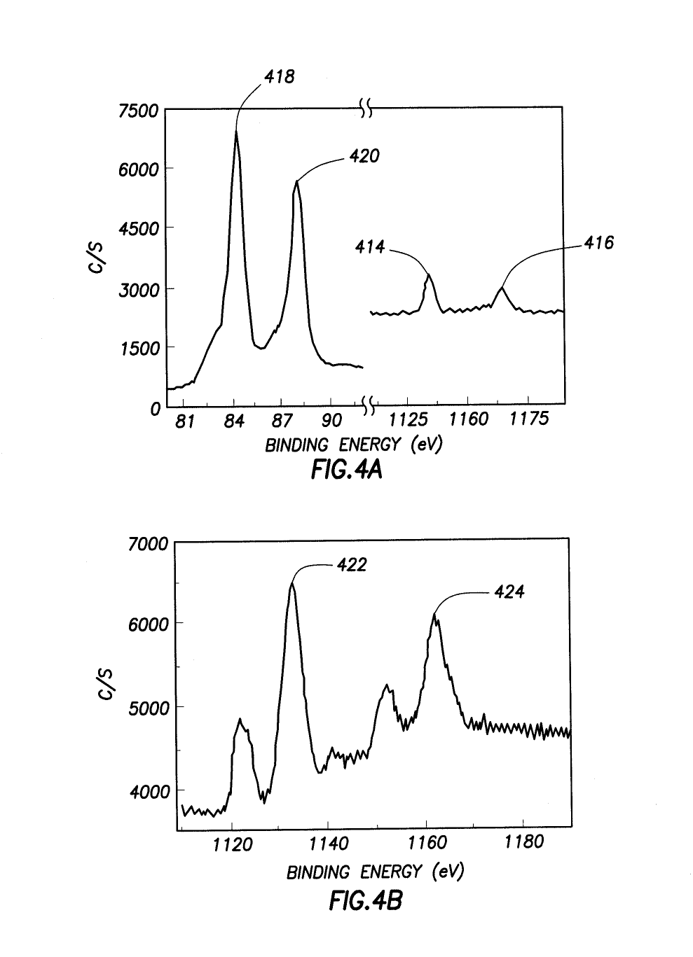

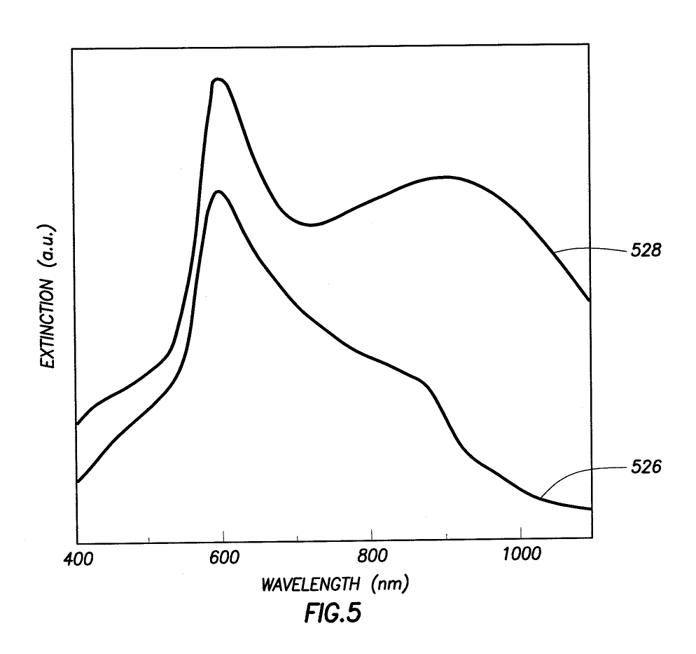

X-ray photoelectron spectroscopy (XPS) and/or energy dispersive x-ray spectroscopy (EDS) measurements may be used to investigate the chemical composition and purity of the nanoparticle structures in the complex. For example, FIG. 4A shows an XPS spectrum in accordance with one or more embodiments of the invention. XPS measurements were acquired with a PHI Quantera X-ray photoelectron spectrometer. FIG. 4A shows the XPS spectra in different spectral regions corresponding to the elements of the nanoshell encapsulated with europium oxide. FIG. 4A shows the XPS spectra display the binding energies for Eu (3 d 5/2) at 1130 eV 414, Eu (2 d 3/2) at 1160 eV 416, Au (4 f 7/2) at 83.6 eV 418, and Au (4 f 5/2) at 87.3 eV 420 of nanoshells encapsulated with europium oxide. For comparison, FIG. 4B shows an XPS spectrum of europium oxide colloids that may be manufactured according to methods known in the art. FIG. 4B shows the XPS spectra display the binding energies for Eu (3 d 5/2) at 1130 eV 422 and Eu (2 d 3/2) at 1160 eV 424 of europium oxide colloids.

In one or more embodiments of the invention, the complex may include solid metallic nanoparticles encapsulated with an additional layer as described above. For example, using the methods described above, solid metallic nanoparticles may be encapsulated using silica, titanium, europium, erbium, samarium, praseodymium, and dysprosium. Examples of solid metallic nanoparticles include, but are not limited to, spherical gold, silver, copper, or nickel nanoparticles or solid metallic nanorods. The specific metal may be chosen based on the plasmon resonance, or absorption, of the nanoparticle when encapsulated. The encapsulating elements may be chosen based on chemical compatibility, the encapsulating elements ability to increase the melting point of the encapsulated nanoparticle structure, and the collective plasmon resonance, or absorption, of a solution of the encapsulated nanostructure, or the plasmon resonance of the collection of encapsulated nanostructures when deposited on a substrate.

In one or more embodiments, the complex may also include copper colloids. Copper colloids may be synthesized using a solution-phase chemical reduction method. For example, 50 mL of 0.4 M aqueous solution of L-ascorbic acid, 0.8 M of Polyvinyl pyridine (PVP), and 0.01 M of copper (II) nitride may be mixed and heated to 70 degree Celsius until the solution color changes from a blue-green color to a red color. The color change indicates the formation of copper nanoparticles. FIG. 5 is an experimental and theoretical spectrum in accordance with one or more embodiments of the invention. FIG. 5 includes an experimental absorption spectrum 526 of copper colloids in accordance with one or more embodiments of the invention. Therefore, copper colloids may be used to absorb electromagnetic radiation in the 550 nm to 900 nm range.

FIG. 5 also includes a theoretical absorption spectrum 528 calculated using Mie scattering theory. In one or more embodiments, Mie scattering theory may be used to theoretically determine the absorbance of one or more nanoparticle structures to calculate and predict the overall absorbance of the complex. Thus, the complex may be designed to maximize the absorbance of solar electromagnetic radiation.

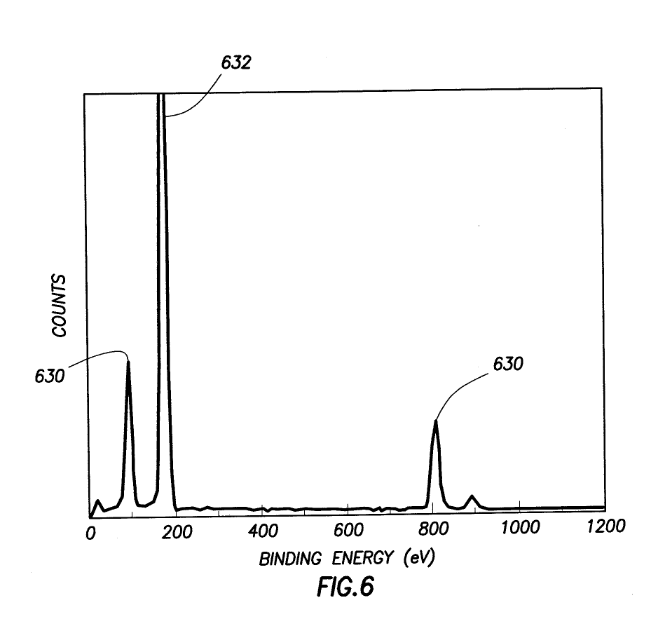

Referring to FIG. 6, an EDS spectrum of copper colloids in accordance with one or more embodiments of the invention is shown. The EDS spectrum of the copper colloids confirms the existence of copper atoms by the appearance peaks 630. During the EDS measurements, the particles are deposited on a silicon substrate, as evidenced by the presence of the silicon peak 632.

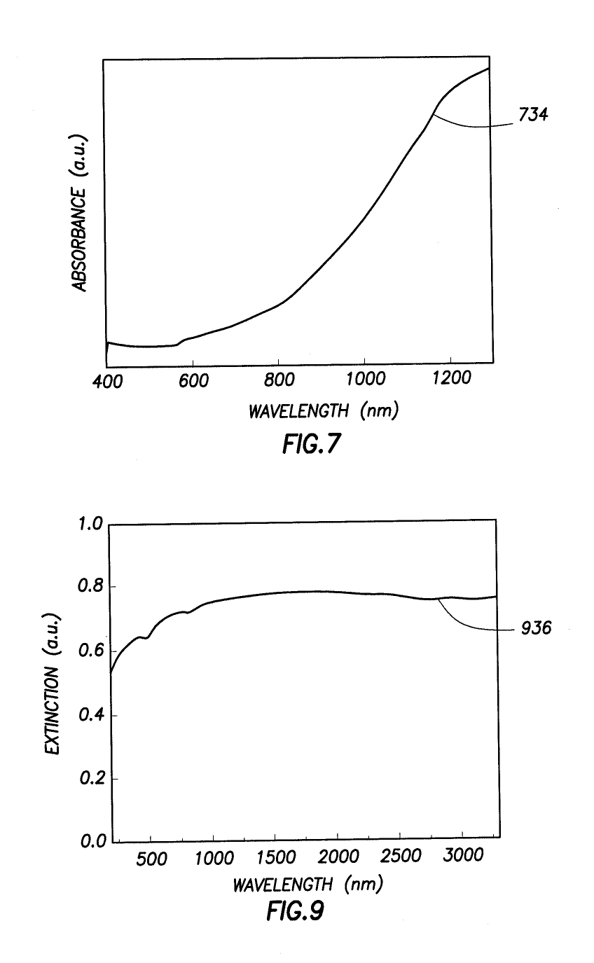

In one or more embodiments, the complex may include copper oxide nanoparticles. Copper oxide nanostructures may be synthesized by 20 mL aqueous solution of 62.5 mM Cu(NO₃)₂ being directly mixed with 12 mL NH₄OH under stirring. The mixture may be stirred vigorously at approximately 80° C. for 3 hours, then the temperature is reduced to 40° C. and the solution is stirred overnight. The solution color turns from blue to black color indicating the formation of the copper oxide nanostructure. The copper oxide nanostructures may then be washed and re-suspended in water via centrifugation. FIG. 7 shows the absorption of copper oxide nanoparticles in accordance with one or more embodiments of the invention. The absorption of the copper oxide nanoparticles 734 may be used to absorb electromagnetic radiation in the region from ˜900 nm to beyond 1200 nm.

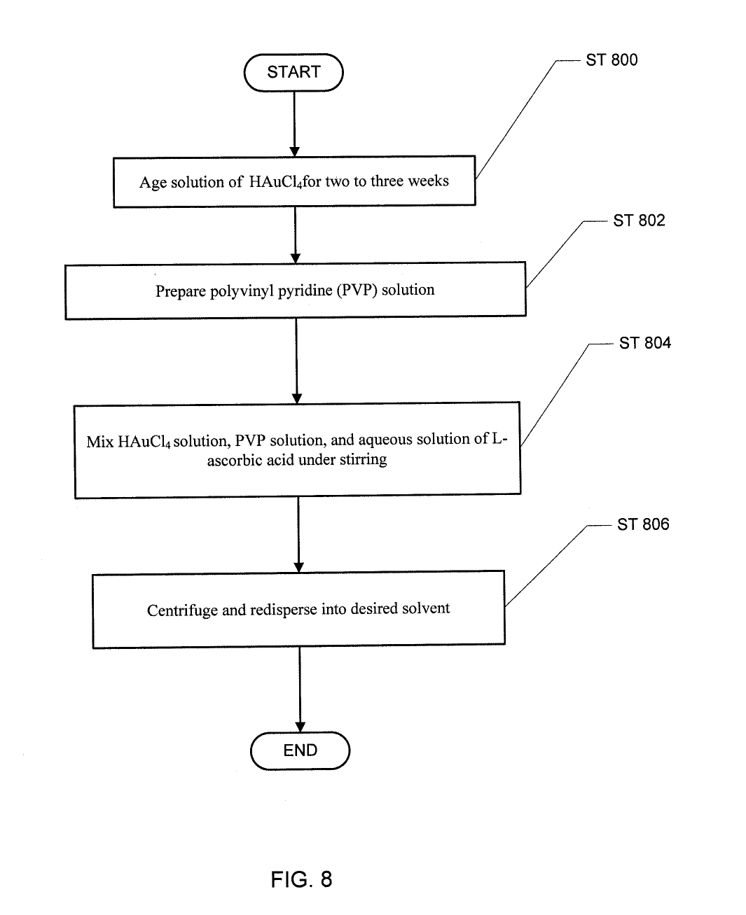

In one or more embodiments of the invention, the complex may include branched nanostructures. One of ordinary skill in the art will appreciate that embodiments of the invention are not limited to strict gold branched structures. For example, silver, nickel, copper, or platinum branched structures may also be used. FIG. 8 is a flow chart of the method of manufacturing gold branched structures in accordance with one or more embodiments of the invention. In ST 800, an aqueous solution of 1% HAuCl₄ may be aged for two-three weeks. In ST 802, a polyvinyl pyridine (PVP) solution may be prepared by dissolving 0.25 g in approximately 20 mL ethanol solution and resealed with water to a final volume of 50 mL. In ST 804, 50 mL of the 1% HAuCl₄ and 50 mL of the PVP solution may be directly mixed with 50 mL aqueous solution of 0.4 M L-ascorbic acid under stirring. The solution color may turn immediately in dark blue-black color which indicates the formation of a gold nanoflower or nano-coral. Then, in ST 806, the Au nanostructures may then be washed and resuspended in water via centrifugation. In other words, the gold branched nanostructures may be synthesized through L-ascorbic acid reduction of aqueous chloroaurate ions at room temperature with addition of PVP as the capping agent. The capping polymer PVP may stabilize the gold branched nanostructures by preventing them from aggregating. In addition, the gold branched nanostructures may form a porous polymer-type matrix.

FIG. 9 shows the absorption of a solution of gold branched nanostructures in accordance with one or more embodiments of the invention. As can be seen in FIG. 9, the absorption spectrum 936 of the gold branched nanostructures is almost flat for a large spectral range, which may lead to considerably high photon absorption. The breadth of the spectrum 936 of the gold branched nanostructures may be due to the structural diversity of the gold branched nanostructures or, in other works, the collective effects of which may come as an average of individual branches of the gold branched/corals nanostructure.

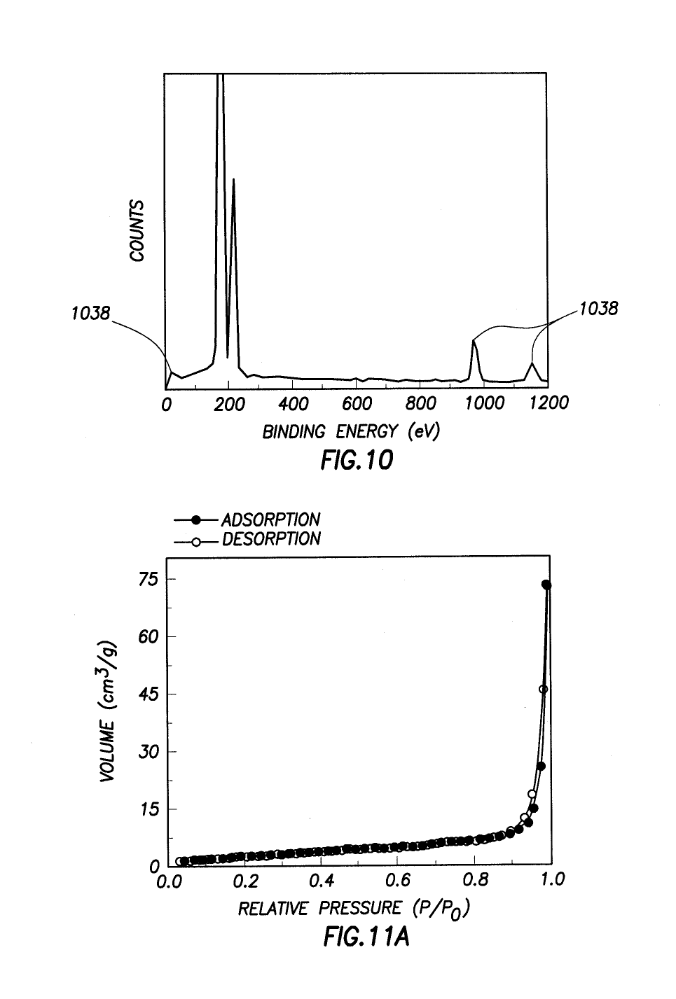

FIG. 10 shows the EDS measurements of the gold branched nanostructures in accordance with one or more embodiments of the invention. The EDS measurements may be performed to investigate the chemical composition and purity of the gold branched nanostructures. In addition, the peaks 1038 in the EDS measurements of gold branched nanostructures confirm the presence of Au atoms in the gold branched nanostructures.

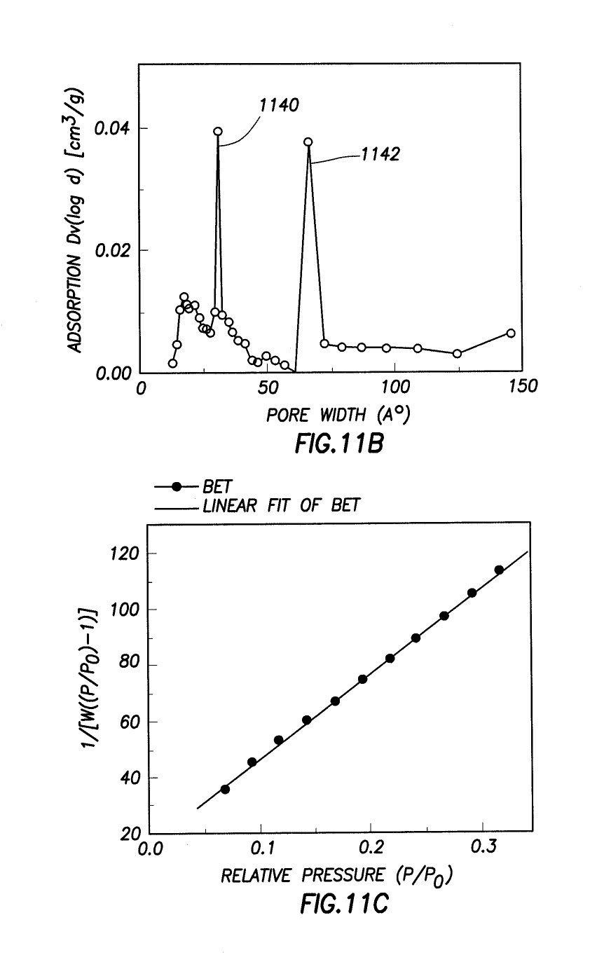

FIG. 11 shows a Brunauer-Emmett-Teller (BET) surface area and pore size distribution analysis of branches in accordance with one or more embodiments of the invention. The BET surface area and pore size may be performed to characterize the branched nanostructures. FIG. 11A presents the nitrogen adsorption-desorption isotherms of a gold corral sample calcinated at 150° C. for 8 hours. The isotherms may exhibit a type IV isotherm with a N₂ hysteresis loops in desorption branch as shown. As shown in FIG. 11A, the isotherms may be relatively flat in the low-pressure region (P/P₀<0.7). Also, the adsorption and desorption isotherms may be completely superposed, a fact which may demonstrate that the adsorption of the samples mostly likely occurs in the pores. At the relative high pressure region, the isotherms may form a loop due to the capillarity agglomeration phenomena. FIG. 11B presents a bimodal pore size distribution, showing the first peak 1140 at the pore diameter of 2.9 nm and the second peak 1142 at 6.5 nm. FIG. 11C shows the BET plots of gold branched nanostructures in accordance with one or more embodiments of the invention. A value of 10.84 m²/g was calculated for the specific surface area of branches in this example by using a multipoint BET-equation.

In one or more embodiments of the invention, the gold branched nanostructures dispersed in water may increase the nucleation sites for boiling, absorb electromagnetic energy, decrease the bubble lifetime due to high surface temperature and high porosity, and increase the interfacial turbulence by the water gradient temperature and the Brownian motion of the particles. The efficiency of a gold branched complex solution may be high because it may allow the entire fluid to be involved in the boiling process.

As demonstrated in the above figures and text, in accordance with one or more embodiments of the invention, the complex may include a number of different specific nanostructures chosen to maximize the absorption of the complex in a desired region of the electromagnetic spectrum. In addition, the complex may be suspended in different solvents, for example water or ethylene glycol. Also, the complex may be deposited onto a surface according to known techniques. For example, a molecular or polymer linker may be used to fix the complex to a surface, while allowing a solvent to be heated when exposed to the complex. The complex may also be embedded in a matrix or porous material. For example, the complex may be embedded in a polymer or porous matrix material formed to be inserted into a particular embodiment as described below. For example, the complex could be formed into a removable cartridge. As another example, a porous medium (e.g., fiberglass) may be embedded with the complex and placed in the interior of a vessel containing a fluid to be heated. The complex may also be formed into shapes in one or more embodiments described below in order to maximize the surface of the complex and, thus, maximize the absorption of EM radiation. In addition, the complex may be embedded in a packed column or coated onto rods inserted into one or more embodiments described below.

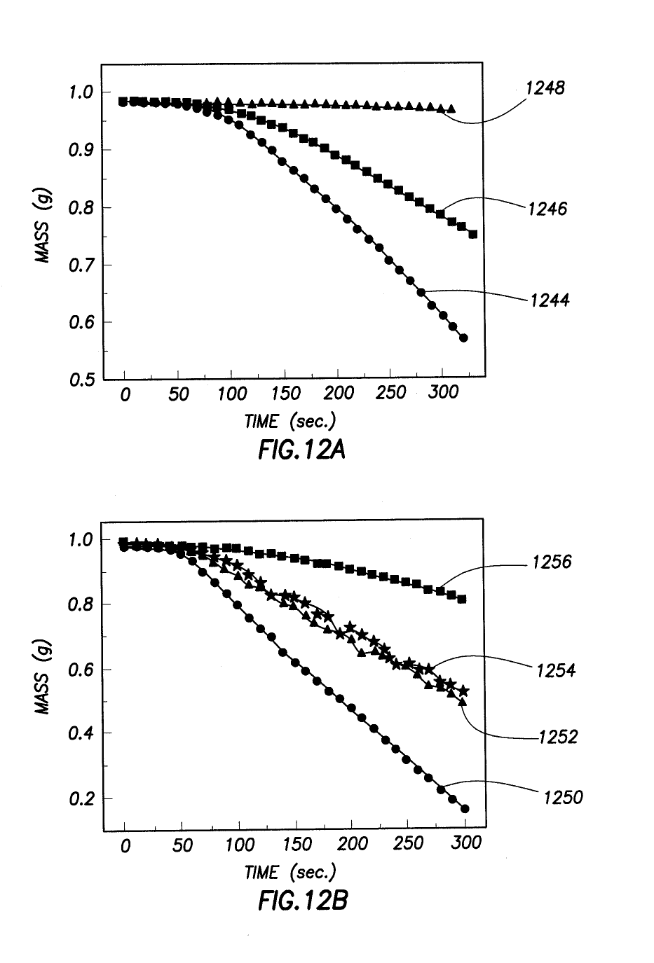

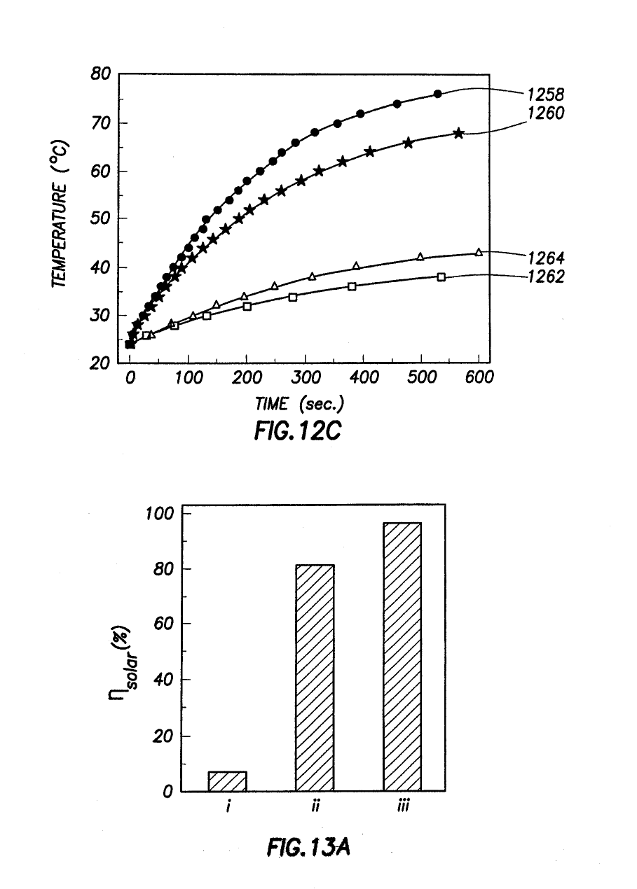

FIGS. 12A-12C show charts of the mass loss and temperature increase of different nanostructures that may be used in a complex in accordance with one or more embodiments of the invention. The results shown in FIGS. 12A-12C were performed to monitor the mass loss of an aqueous nanostructure solution for 10 minutes under sunlight (FIG. 12B) versus non-pulsed diode laser illumination at 808 nm (FIG. 12A). In FIG. 12A, the mass loss versus time of the laser illumination at 808 nm is shown for Eu₂O₃-coated nanoshells 1244, non-coated gold nanoshells 1246, and gold nanoparticles with a diameter of ˜100 nm 1248. Under laser exposure, as may be expected from the absorbance shown in FIG. 3, at 808 nm illumination, the coated and non-coated nanoshells exhibit a mass loss due to the absorbance of the incident electromagnetic radiation at 808 nm. In addition, as the absorbance is lower at 808 nm, the 100 nm diameter gold colloid exhibits little mass loss at 808 nm illumination. In FIG. 12A, the Au nanoparticles demonstrated a lower loss rate that was nearly the same as water because the laser wavelength was detuned from plasmon resonance frequency. The greatest mass loss was obtained by adding a layer around the gold nanoshells, where the particle absorption spectrum was approximately the same as the solar spectrum (see FIG. 3.)

In FIG, 12B, the mass loss as a function of time under exposure to the sun in accordance with one or more embodiments of the invention is shown. In FIG. 12B, the mass loss under sun exposure with an average power of 20 W is shown for Eu₂O₃-coated nanoshells 1250, non-coated gold nanoshells 1252, gold nanoparticles with a diameter of ˜100 nm 1254, and a water control 1256. As in the previous example, the greatest mass loss may be obtained by adding a rare earth or dielectric layer around a nanoshell.

The resulting mass loss curves in FIGS. 12A and 12B show significant water evaporation rates for Eu₂O₃-coated gold nanoshells. The mass loss may be slightly greater under solar radiation because the particles were able to absorb light from a broader range of wavelengths. In addition, the collective effect of aggregates broadens the absorption spectrum of the oxide-coated nanoparticles, which may help to further amplify the heating effect and create local areas of high temperature, or local hot spots. Aggregates may also allow a significant increase in boiling rates due to collective self organizing forces. The oxide layer may further enhance steam generation by increasing the surface area of the nanoparticle, thus providing more boiling nucleation sites per particle, while conserving the light-absorbing properties of the nanostructure.

FIG. 12C shows the temperature increase versus time under the 808 nm laser exposure in accordance with one or more embodiments of the invention. In FIG. 12C, the temperature increase under the 808 nm laser exposure is shown for Eu₂O₃-coated nanoshells 1258, non-coated gold nanoshells 1260, gold nanoparticles with a diameter of ˜100 nm 1262, and a water control 1264. As may be expected, the temperature of the solutions of the different nanostructures that may be included in the complex increases due to the absorption of the incident electromagnetic radiation of the specific nanostructure and the conversion of the absorbed electromagnetic radiation in to heat.

FIG. 13A is a chart of the solar trapping efficiency in accordance with one or more embodiments of the invention. To quantify the energy trapping efficiency of the complex, steam is generated in a flask and throttled through a symmetric convergent-divergent nozzle. The steam is then cooled and collected into an ice bath maintained at 0° C. The nozzle serves to isolate the high pressure in the boiler from the low pressure in the ice bath and may stabilize the steam flow. Accordingly, the steam is allowed to maintain a steady dynamic state for data acquisition purposes. In FIG. 13A, the solar energy capture efficiency (η) of water (i) and Eu2O3-coated nanoshells (ii) and gold branched (ii) nanostructures is shown. The resulting thermal efficiency of steam formation may be estimated at 80% for the coated nanoshell complex and 95% for a gold branched complex. By comparison, water has approximately 10% efficiency under the same conditions.

In one or more embodiments of the invention, the concentration of the complex may be modified to maximize the efficiency of the system. For example, in the case where the complex is in solution, the concentration of the different nanostructures that make up the complex for absorbing EM radiation may be modified to optimize the absorption and, thus, optimize the overall efficiency of the system. In the case where the complex is deposited on a surface, the surface coverage may be modified accordingly.

In FIG. 13B, the steam generation efficiency versus gold nanoshell concentration for solar and electrical heating in accordance with one or more embodiments of the invention is shown. The results show an enhancement in efficiency for both electrical 1366 and solar 1368 heating sources, confirming that the bubble nucleation rate increases with the concentration of complex. At high concentrations, the complex is likely to form small aggregates with small inter-structure gaps. These gaps may create “hot spots”, where the intensity of the electric field may be greatly enhanced, causing an increase in temperature of the surrounding water. The absorption enhancement under electrical energy 1366 is not as dramatic as that under solar power 1368 because the solar spectrum includes energetic photons in the NIR, visible and UV that are not present in the electric heater spectrum. At the higher concentrations, the steam generation efficiency begins to stabilize, indicating a saturation behavior. This may result from a shielding effect by the particles at the outermost regions of the flask, which may serve as a virtual blackbody around the particles in the bulk solution.

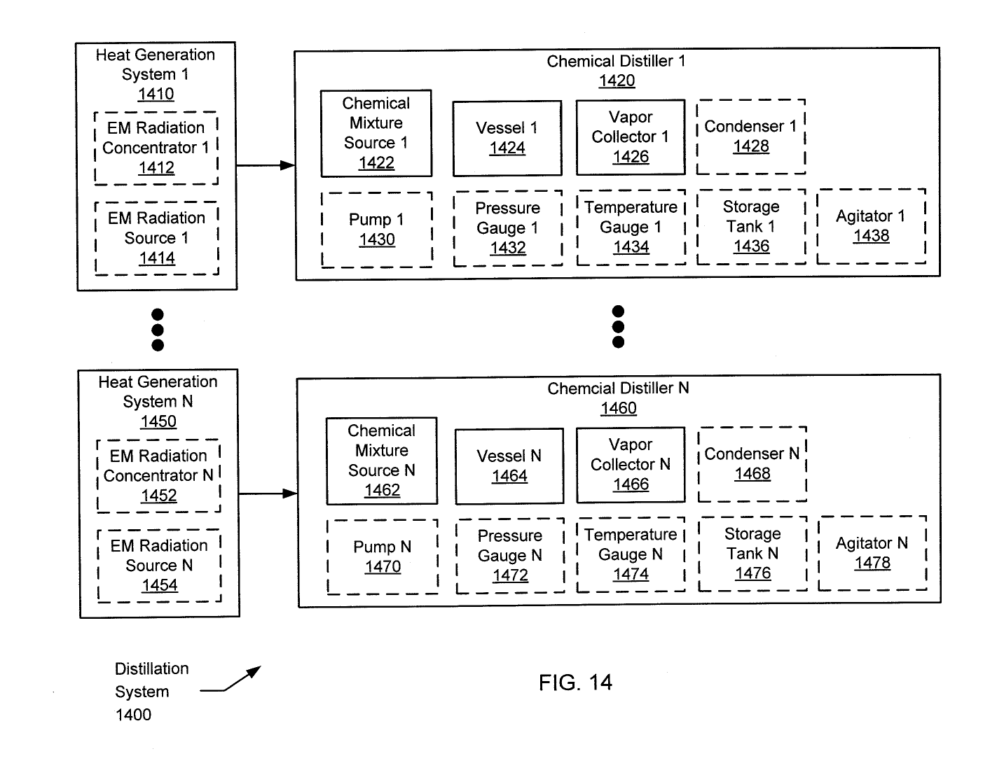

FIG. 14 shows a distillation system 1400 using a complex in accordance with one or more embodiments of the invention. The distillation system 1400 includes one or more heat generation systems (e.g., heat generation system 1 1410, heat generation system N 1450) and one or more chemical distillers (e.g., chemical distiller 1 1420, chemical distiller N 1460). Each heat generation system (e.g., heat generation system 1 1410, heat generation system N 1450) includes, optionally, an EM radiation source (e.g., EM radiation source 1 1414, EM radiation source N 1454) and an EM radiation concentrator (e.g., EM radiation concentrator 1 1412, EM radiation concentrator N 1452). Each chemical distillers (e.g., chemical distiller 1 1420, chemical distiller N 1460) includes a chemical mixture source (e.g., chemical mixture source 1 1422, chemical mixture source N 1462), a vessel (e.g., vessel 1 1424, vessel N 1464), a vapor collector (e.g., vapor collector 1 1426, vapor collector N 1466), and, optionally, a condenser (e.g., condenser 1 1428, condenser N 1468), a pump (e.g., pump 1 1430, pump N 1470), a pressure gauge (e.g., pressure gauge 1 1432, pressure gauge N 1472), a temperature gauge (e.g., temperature gauge 1 1434, temperature gauge N 1474), a storage tank (e.g., storage tank 1 1436, storage tank N 1476), an agitator (e.g., agitator 1 1438, agitator N 1478). Each of these components is described with respect FIG. 14 below. One of ordinary skill in the art will appreciate that embodiments of the invention are not limited to the configuration shown in FIG. 14.

For each component shown in FIG. 14, as well as any other component implied and/or described but not shown in FIG. 14, may be configured to receive material from one component (i.e., an upstream component) of the distillation system 1400 and send material (either the same as the material received or material that has been altered in some way (e.g., vapor to fluid)) to another component (i.e., a downstream component) of the distillation system 1400. In all cases, the material received from the upstream component may be delivered through a series of pipes, pumps, valves, and/or other devices to control factors associated with the material received such as the flow rate, temperature, and pressure of the material received as it enters the component. Further, the fluid and/or vapor may be delivered to the downstream component using a different series of pipes, pumps, valves, and/or other devices to control factors associated with the material sent such as the flow rate, temperature, and pressure of the material sent as it leaves the component.

In one or more embodiments of the invention, each heat generation system 1410 (e.g., heat generation system 1 1410, heat generation system N 1450) of the distillation system 1400 is configured to provide EM radiation. Each heat generation system may be ambient light, as produced by the sun or one or more light bulbs in a room. Optionally, in one or more embodiments of the invention, each EM radiation source (e.g., EM radiation source 1 1414, EM radiation source N 1454) is any other source capable of emitting EM radiation having one or a range of wavelengths. An EM radiation source may be a stream of flue gas derived from a combustion process using a fossil fuel, including but not limited to coal, fuel oil, natural gas, gasoline, and propane. In one or more embodiments of the invention, the stream of flue gas is created during the production of heat and/or electric power using a boiler to heat water using one or more fossil fuels. The stream of flue gas may also be created during some other industrial process, including but not limited to chemical production, petroleum refining, and steel manufacturing. The stream of flue gas may be conditioned before being received by a heat generation system. For example, a chemical may be added to the stream of flue gas, or the temperature of the stream of flue gas may be regulated in some way. Conditioning the stream of flue gas may be performed using a separate system designed for such a purpose.

In one or more embodiments of the invention, each EM radiation source is any other natural and/or manmade source capable of emitting one or more wavelengths of energy. The EM radiation source may also be a suitable combination of sources of EM radiation, whether emitting energy using the same wavelengths or different wavelengths.

Optionally, in one or more embodiments of the invention, each EM radiation concentrator (e.g., EM radiation concentrator 1 1412, EM radiation concentrator N 1452) is a device used to intensify the energy emitted by an EM radiation source. Examples of an EM radiation concentrator include, but are not limited to, one or more lenses (e.g., Fresnel lens, biconvex, negative meniscus, simple lenses, complex lenses), a parabolic trough, black paint, one or more disks, an array of multiple elements (e.g., lenses, disks), or any suitable combination thereof. An EM radiation concentrator may be used to increase the rate at which the EM radiation is absorbed by the complex.

In one or more embodiments of the invention, each chemical distiller (e.g., chemical distiller 1 1420, chemical distiller N 1460) of the distillation system 1400 is configured to receive a chemical mixture from a chemical mixture source (e.g., chemical mixture source 1 1422, chemical mixture source N 1462) in a vessel (e.g., vessel 1 1424, vessel N 1464) to generate a vapor element. A chemical mixture source (e.g., chemical mixture source 1 1422, chemical mixture source N 1462) is where the chemical mixture originates. In one or more embodiments of the invention, a chemical mixture source contains a mixture of the chemical mixture, which includes a number of elements (e.g., compounds, impurities, solids). A chemical mixture source may be any type of source of a chemical mixture, including but not limited to crude oil, vinegar, air (including in liquid form), and a solution that includes an alcohol (e.g., fatty acids mixed with an alcohol, one or more solvents mixed with an alcohol, a fermented solution). The chemical mixture may be any type of fluid. Examples of a chemical mixture may include, but are not limited to, an oil (e.g., light sweet crude, heavy crude, vegetable), vinegar, fermented solutions (e.g., spirits), air, natural gas, wood, petrochemicals, and herbs.

In one or more embodiments of the invention, a vessel (e.g., vessel 1 1424, vessel N 1464) holds the chemical mixture and facilitates the transfer of energy (e.g., heat) to the chemical mixture to generate a vapor of one or more elements in the chemical mixture. A vessel may be designed and configured to operate under a pressure. As an initial matter, those skilled in the art of distillation will appreciate that a number of different distillation feed methods (e.g., batch distillation, continuous distillation) and a number of different processing models and/or methods (e.g., vacuum distillation, column distillation, azeotropic distillation, freeze distillation, steam distillation, fractioning distillation, Raschig rings, extractive distillation, simple distillation, molecular distillation, short path distillation, pervaporation, flash distillation, reactive distillation, dry distillation, codistillation, rotary evaporation, kugelrohr, pressure-swing distillation).

Embodiments of this invention do not create a new distillation model or process. Rather, embodiments of this invention disclose a different way to generate and provide the energy (e.g., heat) used to perform an existing distillation process. Consequently, the various components shown in FIG. 14 for a chemical distiller (e.g., chemical distiller 1 1420, chemical distiller N 1460), plus other components that may exist but are not expressly disclosed herein, are known to those skilled in the art. Further, while FIG. 14 shows multiple heat generation systems and chemical distillers, a single heat generation system and a single chemical distiller may be used to distill multiple elements from a chemical mixture.

A vessel (e.g., vessel 1 1424, vessel N 1464), or a portion thereof, may include the complex. For example, a vessel may include a liquid solution (e.g., the chemical mixture, some other material, liquid or otherwise, such as ethylene glycol or glycine) that includes the complex, be coated on one or more inside surfaces with a coating of the complex, be coated on one or more outside surfaces with a coating of the complex, include a porous matrix into which the complex is embedded, include a packed column that includes packed, therein, a substrate on which the complex is attached, include rods or similar objects coated with the complex and submerged in the liquid solution, be constructed of a material that includes the complex, or any combination thereof. A vessel may also be adapted to facilitate one or more EM radiation concentrators (not shown), as described above.

A vessel may be of any size, material, shape, color, degree of translucence/transparency, or any other characteristic suitable for the operating temperatures and pressures to produce the amount and type of each element from the chemical mixture designed for the application. For example, a vessel may be a large, stainless steel cylindrical tank holding a quantity of solution that includes the complex and with a number of lenses (acting as EM radiation concentrators) along the lid and upper walls. In such a case, the solution may include the chemical mixture to be heated to vaporize one or more elements of the chemical mixture. Further, in such a case, the chemical mixture may include properties such that the complex remains in the chemical mixture when a filtering system (described below) is used. Alternatively, a chemical vessel may be a translucent pipe with the interior surfaces coated (either evenly or unevenly) with a substrate of the complex, where the pipe is positioned at the focal point of a parabolic trough (acting as an EM radiation concentrator) made of reflective metal.

In one or more embodiments of the invention, a chemical distiller includes a vapor collector (e.g., vapor collector 1 1426, vapor collector N 1466). A vapor collector may be a part of, or coupled to, the vessel to collect one or more vapor elements that are heated and separated from the chemical mixture. A vapor collector may also be coupled to a condenser and/or a storage tank (each described below). A vapor collector may also be controlled by, or operate in conjunction with, one or more components (e.g., a fan, a temperature gauge) of a control system (described below).

Optionally, in one or more embodiments of the invention, a condenser (e.g., condenser 1 1428, condenser N 1468) of a chemical distiller is configured to condense the vapor element, as collected by a vapor collector, to a fluid element. A condenser may use air, water, or any other suitable material/medium to cool the vapor element. A condenser may also operate under a particular pressure, such as under a vacuum. Those skilled in the art will appreciate that a condenser may be any type of condenser, now known or to be discovered, adapted to liquefy a vapor.

Optionally, in one or more embodiments of the invention, a chemical distiller includes one or more temperature gauges (e.g., temperature gauge 1 1434, temperature gauge N 1474) to measure a temperature at different points inside a vessel and/or other components of the chemical distiller. For example, a temperature gauge may be placed at the point in a vessel where a vapor element exits the vessel (e.g., a vapor collector). Such temperature gauge may be operatively connected to a control system (not shown) used to control the amount and/or quality of vapor element produced in heating the chemical mixture. In one or more embodiments of the invention, a vessel may be pressurized where the pressure is read and/or controlled using a pressure gauge (e.g., pressure gauge 1 1432, pressure gauge N 1472). Those skilled in the art will appreciate one or more control systems used to create heated fluid in heating the cool fluid may involve a number of devices, including but not limited to the temperature gauges, pressure gauges, pumps (e.g., pump 1 1430, pump N 1470), agitators (e.g., agitator 1 1438, agitator N 1478), fans, and valves, controlled (manually and/or automatically) according to a number of protocols and operating procedures. In one or more embodiments of the invention, the control system may be configured to maintain a maximum temperature (or range of temperatures) of a vessel so that the chemical mixture maintains (or does not exceed) a predetermined temperature.

Optionally, in one or more embodiments of the invention, one or more of the components of a chemical distiller may also include a filtering system (not shown). For example, a filtering system may be located inside a vessel and/or at some point before the chemical mixture enters the vessel. The filtering system may capture impurities (e.g., dirt and other solids, large bacteria, corrosive material) in the chemical mixture that may not be useful or that may inhibit the distillation process. The filtering system may vary, depending on a number of factors, including but not limited to the configuration of the vessel, the configuration of the chemical mixture source, and the purity requirements of a vapor element. The filtering system may be integrated with a control system. For example, the filtering system may operate within a temperature range measured by one or more temperature gauges.

Optionally, in one or more embodiments of the invention, one or more pumps (e.g., pump 1 1430, pump N 1470) may be used in chemical distiller. A pump may be used to regulate the flow of the chemical mixture into a vessel and/or the flow of the fluid element from a condenser (e.g., condenser 1 1428, condenser N 1468). A pump may operate manually or automatically (as with a control system, described above). Each pump may operate using a variable speed motor or a fixed speed motor. The flow of the chemical mixture, a vapor element from a vessel, and/or a fluid element from a condenser may also be controlled by gravity, a fan, pressure differential, some other suitable mechanism, or any combination thereof.

Optionally, in one or more embodiments of the invention, a storage tank (e.g., storage tank 1 1436, storage tank N 1476) of a chemical distiller is configured to store one or more fluid elements and/or vapor elements after the vapor element has been extracted from a vessel. In some embodiments of the invention, the storage tank may be a vessel or a vapor collector.

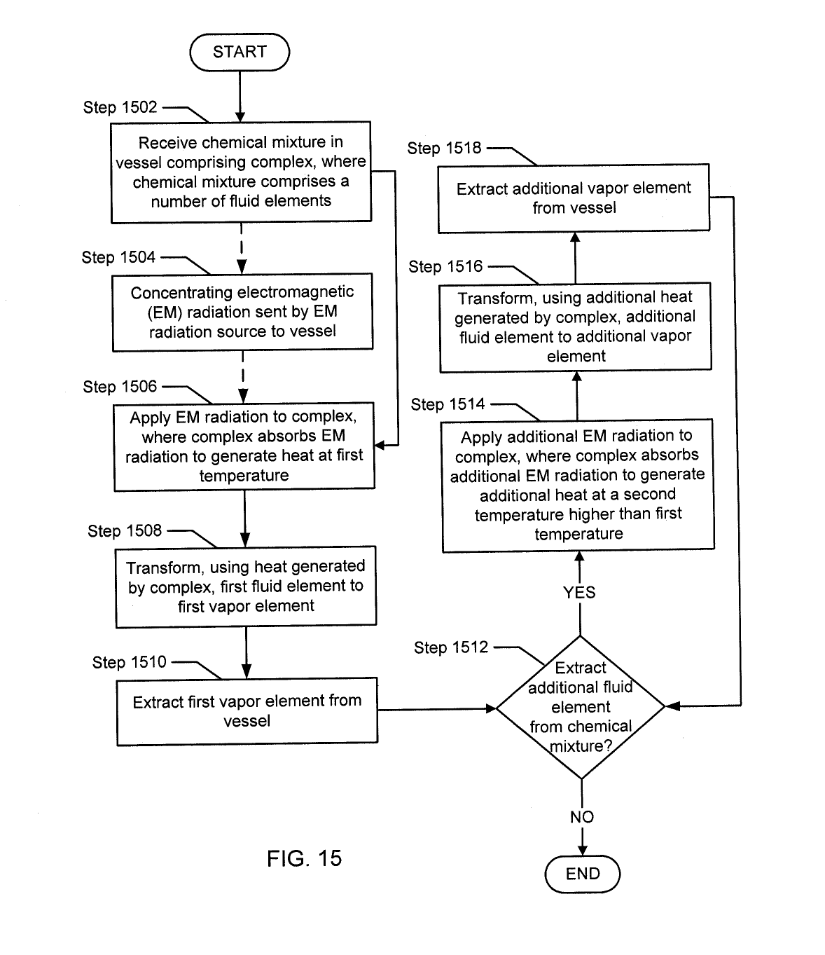

FIG. 15 shows a flowchart for a method for distilling a chemical mixture in accordance with one or more embodiments of the invention. While the various steps in this flowchart are presented and described sequentially, one of ordinary skill will appreciate that some or all of the steps may be executed in different orders, may be combined or omitted, and some or all of the steps may be executed in parallel. Further, in one or more of the embodiments of the invention, one or more of the steps described below may be omitted, repeated, and/or performed in a different order. In addition, a person of ordinary skill in the art will appreciate that additional steps, omitted in FIG. 15, may be included in performing this method. Accordingly, the specific arrangement of steps shown in FIG. 15 should not be construed as limiting the scope of the invention.

Referring to FIG. 15, in Step 1502, a chemical mixture is received in a vessel. In one or more embodiments of the invention, the vessel includes a complex. The chemical mixture may be any liquid. The chemical mixture may include two or more elements. The vessel may be pressurized and may be any container capable of holding a volume of the chemical mixture. For example, the vessel may be a pipe, a chamber, or some other suitable container. In one or more embodiments of the invention, the vessel is adapted to maintain its characteristics (e.g., form, properties) under high temperatures and/or pressures for extended periods of time. The complex may be part of a solution inside the vessel, a coating on the outside of the vessel, a coating on the inside of the vessel, integrated as part of the material of which the vessel is made, integrated with the vessel in some other way, or any suitable combination thereof. The chemical mixture may be received from any source suitable for providing the chemical mixture. The chemical mixture may be received in the vessel using gravity, pressure differential, a pump, a valve, a regulator, some other device to control the flow of the chemical mixture, or any suitable combination thereof.

Optionally, in Step 1504, EM radiation sent by an EM radiation source (described above with respect to FIG. 14) to the vessel is concentrated. In one or more embodiments of the invention, the EM radiation is concentrated using an EM radiation concentrator, as described above with respect to FIG. 14. For example, the EM radiation may be concentrated using one or more lenses or a parabolic trough. In one or more embodiments of the invention, the EM radiation is concentrated merely by exposing the vessel to the EM radiation.

In Step 1506, the EM radiation is applied to the complex. In one or more embodiments of the invention, the complex absorbs the EM radiation to generate heat. The heat may be at a certain temperature. The EM radiation may be applied to all or a portion of the complex contained in the vessel. The EM radiation may also be applied to an intermediary, which in turn applies the EM radiation (either directly or indirectly, as through convection) to the complex. A control system using, for example, one or more temperature gauges, may regulate the amount of EM radiation applied to the complex, thus controlling the amount of heat (and associated temperature) generated by the complex at a given point in time. Power required for any component in the control system may be supplied by any of a number of external sources (e.g., a battery, a photovoltaic solar array, alternating current power, direct current power).

In Step 1508, a fluid element from the chemical mixture is heated to generate a vapor element. In other words, the chemical mixture is heated to a temperature (described above with respect to Step 1506) that exceeds the boiling point of one of the elements in the chemical mixture but is below the boiling point of each of the other elements in the chemical mixture. In one or more embodiments of the invention, the chemical mixture is heated using the heat generated by the complex. A control system may be used to monitor and/or regulate the temperature of the chemical mixture and/or the vapor element. The vapor element that is extracted from the vessel may be stored in a storage tank, condensed (using, for example, a condenser) to a fluid element and stored in a storage tank, sent directly to another process, or otherwise suitably stored and/or used.

In Step 1510, the vapor element is extracted from the vessel. In one or more embodiments of the invention, a pump, pressure differential, and/or a fan is used to extract the vapor element from the vessel. Extraction of the vapor element from the vessel may be controlled by a control system. For example, a fan of a control system may operate when the chemical mixture reaches a threshold temperature inside the vessel, as read by a temperature gauge.

In Step 1512, a determination is made as to whether another element is extracted from the remainder of the chemical mixture (i.e., the elements of the chemical mixture that have not already been extracted). If no other element is extracted from the chemical mixture, then the process ends. If another element is extracted from the chemical mixture, then the process proceeds to Step 1514. Determining whether another element is extracted from the remainder of the chemical mixture may be a manual decision (e.g., an operator of the distillation process adjusts one or more controls for one or more components of the distillation system) or an automatic decision (e.g., a control system has been pre-programmed to extract certain elements from the chemical mixture).

In Step 1514, additional EM radiation is applied to the complex. In one or more embodiments of the invention, the complex absorbs the additional EM radiation to generate heat. The heat in this Step 1514 may be at a certain temperature that is higher than the temperature described above with respect to Step 1506. The EM radiation may be applied to all or a portion of the complex contained in the vessel. The EM radiation may also be applied to an intermediary, which in turn applies the EM radiation (either directly or indirectly, as through convection) to the complex. A control system may regulate the amount of additional EM radiation applied to the complex, thus controlling the amount of heat (and the associated increase in temperature) generated by the complex at a given point in time.

In Step 1516, an additional fluid element from the remainder of the chemical mixture is heated to generate an additional vapor element. In other words, the chemical mixture is heated to an increased temperature (described above with respect to Step 1514) that exceeds the boiling point of the additional element in the remainder of the chemical mixture but is below the boiling point of each of the other elements in the remainder of the chemical mixture. In one or more embodiments of the invention, the remainder of the chemical mixture is heated using the heat generated by the complex. A control system may be used to monitor and/or regulate the temperature of the remainder of the chemical mixture and/or the additional vapor element.

In Step 1518, the additional vapor element is extracted from the vessel. In one or more embodiments of the invention, a pump, pressure differential, and/or a fan is used to extract the additional vapor element from the vessel. Extraction of the additional vapor element from the vessel may be controlled by a control system. For example, a fan of a control system may operate when the remainder of the chemical mixture reaches a threshold temperature inside the vessel, as read by a temperature gauge. The additional vapor element that is extracted from the vessel may stored in a storage tank, condensed (using, for example, a condenser) to an additional fluid element and stored in a storage tank, sent directly to another process, or otherwise suitably stored and/or used. After completing Step 1518, the process reverts to Step 1512.

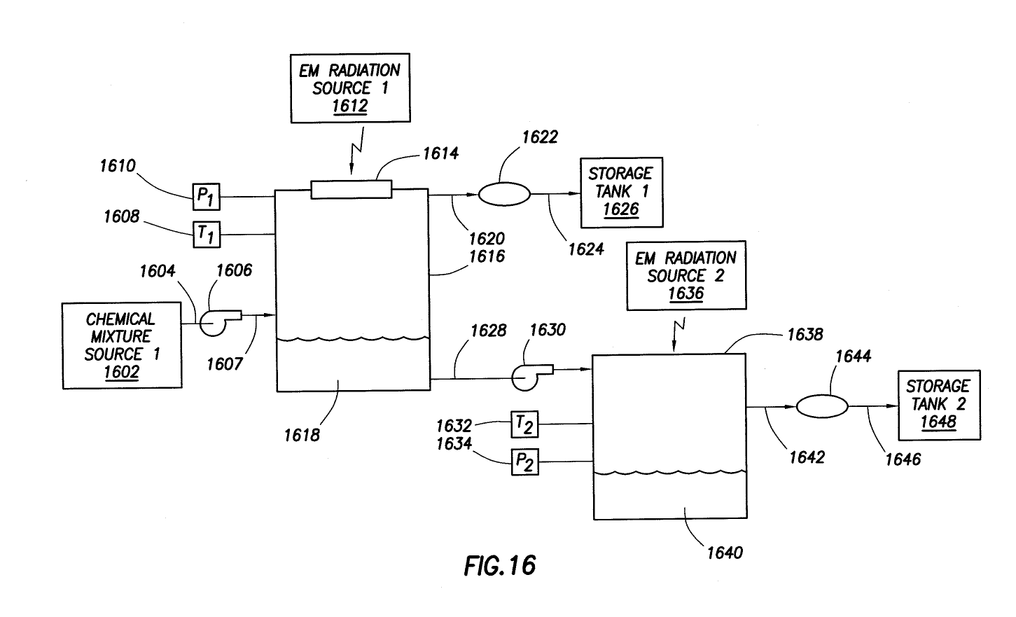

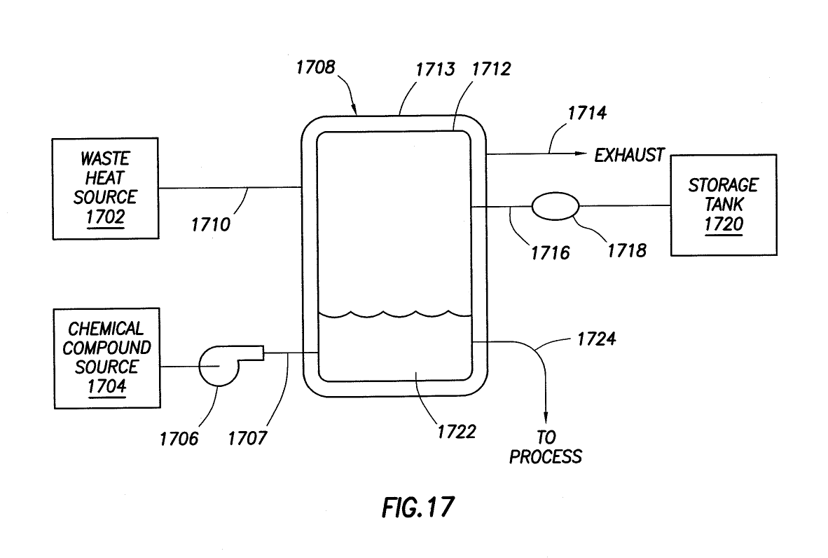

FIGS. 16 and 17 show examples of various embodiments of the invention. Specifically, FIGS. 16 and 17 show distillation systems using embodiments of the invention.

### EXAMPLE

### Multiple Distillers

Consider the following example, shown in FIG. 16, which describes a process for distilling a chemical mixture in accordance with one or more embodiments described above. In this example, the chemical mixture originates from chemical mixture source 1 1602. Chemical mixture source 1 may be any source of a chemical mixture, including but not limited to a mashing vessel, air, a boiler, a chemical vat, and a crude oil tank. The chemical mixture may be treated or untreated. The chemical mixture may also be filtered or unfiltered. The chemical mixture may be extracted from chemical mixture source 1 1602 using gravity, pressure differential, a pump 1606, a valve, a fan, hydraulic pressure, any other suitable method of extracting and/or moving the chemical mixture, or any combination thereof In this example, a pump 1606 is used.

The chemical mixture may be extracted from chemical mixture source 1 1602 through piping 1604 before reaching a vessel 1616 with complex. The complex may be incorporated into the vessel 1616 in one of a number of ways. For example, the complex may be applied to one or more inside surfaces of the vessel. In such a case, the complex may not be applied evenly (i.e., non-uniformly), so that a greater amount of surface area of the complex may come in direct contact with the chemical mixture in the vessel. The greater amount of surface area may allow for a greater transfer of heat from the vessel (i.e., the complex) to the chemical mixture. The complex may also be applied evenly (i.e., uniformly) to the inside surface of the vessel. Alternatively, the complex may be applied to the outer surface of the vessel as an even coating. The complex may also be applied to, or integrated with, the pipe 1607 through which the chemical mixture flows to reach the vessel. Those skilled in the art will appreciate that integrating the complex with the vessel and/or pipe (or any other component that contacts the chemical mixture) may occur in any of a number of other ways.

In this example, the complex is suspended in the chemical mixture 1618 in the vessel 1616. The complex is configured to absorb EM radiation from an EM radiation source (e.g., EM radiation source 1 1612, EM radiation source 2 1636). Upon absorbing the EM radiation, the complex generates heat. When an EM radiation concentrator is used, as with the lens 1614 shown in FIG. 16, the EM radiation absorbed by the complex becomes more intense, which increases the heat generated by the complex.

The chemical mixture 1618 receives the heat generated by the complex inside the vessel 1616. To regulate operating conditions of the chemical mixture in the vessel 1616, a control system may be used. The control system may be integrated with the control of the extraction and flow of the chemical mixture, if any, from chemical mixture source 1 1602, described above. To control the operating conditions of the vessel 1616, a number of different instruments may be used. For example, temperature gauges (e.g., T1 1608), pressure gauges (e.g., P1 1610), photocells, pumps, fans, and other devices may be used, either separately or in combination. In this example, a pump 1606, temperature gauge T1 1608, and pressure gauge P1 1610 are used in one vessel (vessel 1616). Similarly, a pump 1630, temperature gauge T2 1632, and pressure gauge P2 1634 are used in the other vessel (vessel 1638) shown in FIG. 16. For example, T1 1608 may measure the temperature of the vapor element separated from the chemical mixture in the vessel 1616. The readings from T1 1608 and P1 1610 may allow the control system to adjust one or more operating factors to meet designated parameters. For example, if the temperature of the vessel 1616 is too low at T1 1608, the control system may adjust the angle of the lens 1614 and/or expose more of the lens 1614 to EM radiation source 1 1612 to increase the temperature read by T1 1608.

Upon leaving the vessel 1616, the vapor element rises to a vapor collector (e.g., pipe 1620), where the vapor element is sent to a condenser 1622. The condenser 1622 may condense the vapor element to generate fluid element, which is sent from the condenser 1622 through piping 1624 to storage tank 1 1626.

In embodiments of the invention, a filtering system (not shown) may be integrated with one or more vessels (e.g., vessels 1616, 1638) to remove certain impurities (e.g., dirt, solids, large bacteria) from the chemical mixture and/or a vapor element. Similar filtering systems may also be used in other portions of this system and may include filtration of a fluid element.

In this example, the remainder of the chemical mixture (i.e., the elements of the chemical mixture that remain in fluid form after the vapor element is separated from the chemical mixture in the vessel 1616) is removed from vessel 1616 through piping 1628 using pump 1630. The pump 1630 then sends the remainder of the chemical mixture to a separate vessel 1638. In embodiments of the invention, the chemical mixture may remain in one vessel, where additional elements of the remainder of the chemical mixture are vaporized and separated from the chemical mixture by, for example, increasing the temperature of the vessel. When the complex is suspended in the remainder of the chemical mixture in vessel 1616 (as in this example), the complex may be filtered from the remainder of the chemical mixture before being removed from vessel 1616. Additional complex may also be added to the chemical mixture 1616 in vessel 1616 as the remainder of the chemical mixture is removed from vessel 1618 with complex remaining suspended in the remainder of the chemical mixture.

In vessel 1638, the EM radiation concentrator is a black point covering the vessel 1638, which is also coated on one or more of the interior surfaces with the complex. The process described above with respect to vessel 1616 is repeated with the remainder of the chemical mixture 1640 in vessel 1638. In other words, the temperature gauge T2 1632, pressure gauge P2 1634, EM radiation source 2 1636, vapor collector (i.e., pipe 1642), condenser 1644, and storage tank 2 1648 perform substantially similar functions to those performed by the corresponding components described above in this example. As discussed above, the process of heating the chemical mixture to generate a vapor element may occur in a number of ways other than the ways shown in FIG. 16.

### Single Distillers Using Waste Heat

FIG. 17 shows an example of a distillation system using embodiments of the invention. As with the example described above with respect to FIG. 16, a chemical mixture source 1704 is used to provide a chemical mixture. In this example, a pump 1706 is used to extract the chemical mixture from the chemical mixture source 1704 and send the chemical mixture to a vessel 1708. The vessel 1708 in this example has an inner wall 1712 and an outer wall 1713. Between the inner wall 1712 and the outer wall 1713 is a space within which waste heat flows from a waste heat source 1702 through piping 1710. In this case, the waste heat is EM radiation and the waste heat source 1702 is an EM radiation source. The space between the inner wall 1712 and the outer wall 1713 may have channels or similar configuration to allow the waste heat to flow in a particular path, exiting through an exhaust pipe 1714. When the inner wall 1712 of the vessel 1708 is coated with complex and/or complex is integrated with the material of the inner wall 1712, the complex absorbs the energy emitted by the waste heat. The complex then generates heat, which heats the chemical mixture 1722. When the chemical mixture 1722 reaches a temperature above the boiling point of one of the elements of the chemical mixture 1722, then the element transforms from a fluid to a vapor and rises to the top portion of the vessel 1708.

As the vapor element rises in the vessel 1708, the vapor element is collected by a vapor collector (i.e., pipe 1716), where the vapor element is fed to a condenser 1718. In the condenser 1718, the vapor element is condensed into a fluid element. Subsequently, the fluid element is sent to a storage tank 1720. Further, the remainder of the chemical mixture 1722 is sent from the vessel 1708 to a process using piping 1724. Before removing the remainder of the chemical mixture 1722, however, the temperature inside the vessel 1708 may continue to increase, causing additional elements in the remainder of the chemical mixture to vaporize and separate. Such a process may be used in batch processing, where only a limited amount of chemical mixture 1722 is processed in the vessel 1708 at one time, as opposed to a continuous stream of chemical mixture 1722 being introduced into the vessel 1708.

One or more embodiments of the invention heat a chemical mixture to extract one or more elements of the chemical mixture through vaporization. The amount of chemical mixture that is heated by embodiments of the invention may range from a few ounces to thousands of gallons (or more) of chemical mixture. Embodiments of the invention may be used in a variety of industries using a variety of chemical mixtures. For example, a perfume maker may use embodiments of the invention to make perfume from a chemical mixture. A biofuels manufacturer may use embodiments of the invention to make an alcohol-based fuel, such as ethanol. A distillery may use embodiments of the invention to make a hard liquor, such as vodka. Wood may be distilled using embodiments of the invention to form charcoal and/or methanol. A refinery may use embodiments of the invention to distill crude oil into bitumen, fuel oil, heavy gas oil, light gas oil, jet fuel, naphtha, and other byproducts. Other applications, described previously herein and/or known to those of skill in the art, may use embodiments of the invention for distilling a chemical mixture.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of distilling a chemical mixture, the method comprising:
receiving, in a vessel comprising a complex, the chemical mixture comprising a plurality of fluid elements, wherein the complex is a least one selected from a group consisting of copper nanoparticles, copper oxide nanoparticles, nanoshells, nanorods, carbon moieties, encapsulated nanoshells, encapsulated nanoparticles, and branched nanostructures;
applying electromagnetic (EM) radiation to the complex, wherein the complex absorbs the EM radiation to generate heat at a first temperature;
transforming, using the heat generated by the complex, a first fluid element of the plurality of fluid elements of the chemical mixture to a first vapor element; and
extracting the first vapor element from the vessel.

2. The method of claim 1, further comprising:
condensing, using a condenser, the first vapor element to the first fluid element; and
storing the first fluid element in a storage tank.

3. The method of claim 1, further comprising:
applying additional EM radiation to the complex, wherein the complex absorbs the additional EM radiation to generate additional heat at a second temperature greater than the first temperature;
transforming, using the additional heat generated by the complex, a second fluid element of the plurality of fluid elements of the chemical mixture to a second vapor element; and
extracting the second vapor element from the vessel.

4. The method of claim 1, further comprising:
concentrating the EM radiation applied to the vessel using a concentrator, wherein the concentrator is a lens integrated with a surface of the vessel.

5. The method of claim 1, wherein the chemical mixture is crude oil and wherein the first vapor element is one selected from a group consisting of bitumen, fuel oil, heavy gas oil, light gas oil, jet fuel, and naphtha.

6. The method of claim 1, wherein the EM radiation is one selected from a group consisting of waste heat and exhaust gas.

7. A system for distilling a chemical mixture, the system comprising:
a vessel comprising a complex and configured to:
receive the chemical mixture comprising a plurality of elements;
apply electromagnetic (EM) radiation to the complex, wherein the complex absorbs the EM radiation to generate heat; and
transform, using the heat generated by the complex, a first fluid element of the plurality of fluid elements in the first vessel to a first vapor element,
wherein the remainder of the plurality of fluid elements forms a modified chemical mixture in the vessel, and
wherein the complex is at least one selected from a group consisting of copper nanoparticles, copper oxide nanoparticles, nanoshells, nanorods, carbon moieties, encapsulated nanoshells, encapsulated nanoparticles, and branched nanostructures.

8. The system of claim 7, further comprising:
a vapor collector configured to collect the first vapor element; and
a condenser configured to receive the first vapor element from the vapor collector and condense the first vapor element to the first fluid element.

9. The system of claim , 7 further comprising:
an agitator configured to agitate the chemical mixture to assist in transforming the first fluid element to the first vapor element.

10. The system of claim 7, further comprising:
a control system adapted to control an amount of the chemical mixture, wherein the control system comprises a first pump, a temperature gauge, and a pressure gauge.

11. The system of claim 7, wherein the first vessel comprises:
an EM radiation concentrator configured to intensify the EM radiation received from an EM radiation source.

12. The system of claim 11, wherein the EM radiation concentrator is one selected from a group consisting of a lens and a parabolic trough and wherein the vessel is a section of pipe coated with the complex.

13. The system of claim 7, wherein the complex is coated on an interior surface of the vessel.

14. The system of claim 7, wherein the complex is suspended in the chemical mixture in the vessel.
